(19) United States
(12) Patent Application Publication
(10) Pub. No.: US 2023/0217386 A1
(43) Pub. Date: Jul. 6, 2023

(54) On-Demand Procedure for Requesting 5G Time Reference

(71) Applicant: Telefonaktiebolaget LM Ericsson (PUBL), Stockholm (SE)

(72) Inventor: Antonino ORSINO, Kirkkonummi (FI)

(21) Appl. No.: 17/919,881

(22) PCT Filed: Apr. 19, 2021
(86) PCT No.: PCT/EP2021/060129

§ 371 Date: Oct. 19, 2022

Related U.S. Application Data
(60) Provisional application No. 63/012,809, filed on Apr. 20, 2020.

(51) Int. Cl. H04W 56/00; H04W 76/20

(52) U.S. Cl. CPC H04W 56/0015; H04W 76/20

(57) ABSTRACT

Methods and apparatus are provided to enable on-demand requests for a time reference for time-sensitive communications (TSC). The network can optionally configure a UE to enable on-demand requests for TSC. When the UE needs a time reference for TSC, the UE sends a message to the network including an explicit indication that a time reference for TSC is needed by the UE. In response to the request, the network sends to the UE on-demand system information comprising the time reference in a broadcast message or a dedicated message.

### RELATED APPLICATIONS

This application claims priority to U.S. Application No. 63/012809, filed 20 Apr. 2020, the disclosure of which is incorporated in its entirety by reference herein.

### TECHNICAL FIELD

The present disclosure relates generally to time-sensitive communications (TSC) and, more particularly, to an on-demand procedure for requesting time reference information for TSC.

### BACKGROUND

The 5G system (5GS) has been extended to support TSC as defined in the Institute of Electrical and Electronics Engineers (IEEE) standard 802.Qcc. To support TSC, the user equipment (UE) needs to acquire a time reference from the network for synchronization. Although, the existing specifications include on-demand procedures for requesting system information blocks (SIBs), the on-demand procedures currently in use are not adequate to ensure that time reference information for TSC will be provided to the UE. 5G reference time information for synchronization is contained in SIB9, which includes two fields: 1) the timelnfo field and 2) the referenceTimelnfo-r16 field. For TSC, the referenceTimelnfo-r16 field is needed by the UE for synchronization. While the UE in Radio Resource Control (RRC) Idle mode or RRC Inactive mode can request SIB9 using existing procedures, both of the time info and referenceTimelnfo-r16 fields are optional so there is no guarantee that the network will provide the time reference information that is needed by the UE for TSC. If the UE does not receive the time reference information needed for TSC, the lack of synchronization between the network and the UE may prevent TSC communication. Even if the UE is able to achieve course synchronization, it may not be able to meet QoS requirements for TSC communications.

### SUMMARY

Methods and apparatus are provided to enable on-demand requests for a time reference for time-sensitive communications (TSC). The methods and solutions herein described allow the UE to explicitly request on-demand system information comprising the time reference information needed to enable TSC by including an explicit indication in a message sent by the UE to the base station. The network will be aware on what information needs to be signaled in order to enable 5G synchronization for TSC and will provide the required time reference information to the UE.

A first aspect of the disclosure comprises methods implemented by a UE of obtaining time information. In one embodiment, the method comprises sending, to a base station, a message including an indication that a 5G time reference is needed by the UE. The method further comprises receiving from the base station, responsive to the indication, system information comprising the 5G time reference.

A second aspect of the disclosure comprises a UE configured to obtain time information. In one embodiment, the UE is configured to send, to a base station, a message including an indication that a 5G time reference is needed by the UE. The UE is further configured to receive from the base station, responsive to the indication, system information comprising the 5G time reference.

A third aspect of the disclosure comprises a UE configured to obtain time information. In one embodiment, the UE comprises interface circuitry and processing circuitry. The processing circuitry is configured to send, to a base station, a message including an indication that a 5G time reference is needed by the UE. The processing circuitry is further configured to receive from the base station, responsive to the on-demand request, system information comprising the 5G time reference.

A fourth aspect of the disclosure comprises a computer program comprising executable instructions that, when executed by a processing circuit in a UE in a wireless communication network, causes the UE to perform the method according to the first aspect.

A fifth aspect of the disclosure comprises a carrier containing a computer program according to the fourth aspect, wherein the carrier is one of an electronic signal, optical signal, radio signal, or non-transitory computer readable storage medium.

A sixth aspect of the disclosure comprises methods implemented by a base station for providing a 5G time reference for TSC according to a first embodiment. In one embodiment, the method comprises receiving, from the UE, a message including an indication that a 5G time reference is needed by the UE for TSC. The method further comprises sending to the UE, responsive to the indication, system information comprising the 5G time reference f.

A seventh aspect of the disclosure comprises a base station configured to provide a 5G time reference for TSC according to a first embodiment. In one embodiment, the base station is configured to receive, from the UE, a message including an indication that a 5G time reference is needed by the UE. The base station is further configured to send to the UE, responsive to the indication, system information comprising the 5G time reference.

An eighth aspect of the disclosure comprises a base station configured to provide a 5G time reference for TSC according to a first embodiment. The base station includes interface circuitry and processing circuitry. The processing circuitry is configured to receive, from the UE, a message including an indication that a 5G time reference is needed by the UE for TSC. The processing circuitry is further configured to send to the UE, responsive to the indication, system information comprising the 5G time reference.

A ninth aspect of the disclosure comprises a computer program comprising executable instructions that, when executed by a processing circuit in a base station in a wireless communication network, causes the base station to perform the method according to the sixth aspect.

A tenth aspect of the disclosure comprises a carrier containing a computer program according to the ninth aspect, wherein the carrier is one of an electronic signal, optical signal, radio signal, or non-transitory computer readable storage medium.

### BRIEF DESCRIPTION OF THE DRAWINGS

FIG. 1 illustrates a 5G system integrated with a time-sensitive network.

FIG. 2 illustrates an exemplary method implemented by a UE for obtaining a 5G time reference according to a first embodiment.

FIG. 3 illustrates an exemplary method implemented by a UE for obtaining a 5G time reference according to a second embodiment.

FIG. 4 illustrates an exemplary method implemented by a UE for obtaining a 5G time reference according to a third embodiment.

FIG. 5 illustrates an exemplary method implemented by a base station for providing a 5G time reference according to a first embodiment.

FIG. 6 illustrates an exemplary method implemented by a base station for providing a 5G time reference according to a second embodiment.

FIG. 7 illustrates an exemplary method implemented by a base station for providing a 5G time reference according to a third embodiment.

FIG. 8 illustrates an exemplary UE configured for obtaining a 5G time reference according to a first embodiment.

FIG. 9 illustrates an exemplary base station for providing a 5G time reference according to a first embodiment.

FIG. 10 illustrates the main functional components of a UE configured to operate as herein described.

FIG. 11 illustrates the main functional components of a base station configured to operate as herein described.

FIG. 12 is a schematic block diagram illustrating an example wireless network, according to particular embodiments of the present disclosure.

FIG. 13 is a schematic block diagram illustrating an example of a user equipment, according to particular embodiments of the present disclosure.

FIG. 14 is a schematic illustrating an example telecommunication network, according to particular embodiments of the present disclosure.

FIG. 15 is a schematic block diagram illustrating an example communication system, according to particular embodiments of the present disclosure.

FIGS. 16-19 are flow diagrams, each of which illustrates an example method implemented in a communication system, according to particular embodiments of the present disclosure.

### DETAILED DESCRIPTION

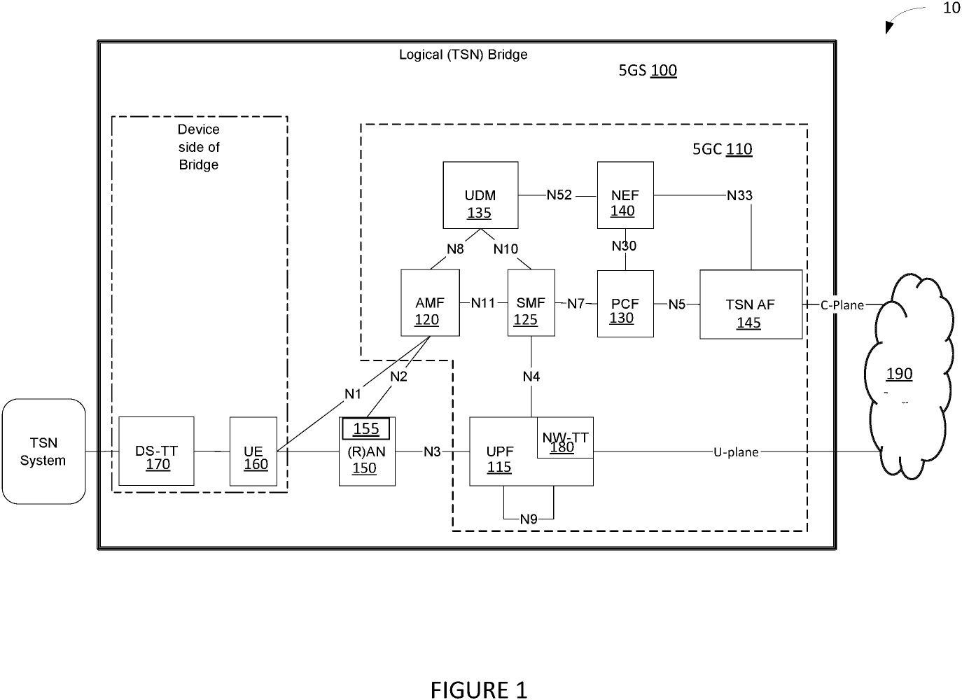

FIG. 1 illustrates a 5G system (5GS) 100 integrated with a time sensitive network (TSN) 10 as a logical TSN bridge. The 5GS 100 includes a 5G core (5GC) 110 and a 5G radio access network (RAN) 150 including one or more 5G base stations 155. The 5GC 110 comprises a User Plane Function (UPF) 115, Access and Mobility Management Function (AMF) 120, Session Management Function (SMF) 125, Policy Control Function (PCF) 130, a Unified Data Management (UDM) function 135, a Network Exposure Function (NEF) 140 and a TSN Application Function (AF) 145. The 5GC 110 is connected to an external packet data network 190. The 5G RAN 150 comprises one or more base stations 155 for communication with user equipment (UEs) 160. The base stations 155 are referred to a 5G NodeBs (gNBs) in applicable standards. The base stations 155 communicate with user equipment UEs 160 within the 5GS 100. The UEs 100 may comprise any type of end user device such as smart phone, tablet, laptop computer, machine-type communication (MTC) device, Internet of Things (IoT) device, etc.

The “logical” TSN bridge implemented by the 5GS 100 includes TSN translator (TT) functionality for interoperation between TSN 10 and 5GS 100 both for user plane and control plane. The 5GS TSN translator functionality comprises a device-side TSN translator (DS-TT) 170 and network-side TSN translator (NW-TT) 180. 5GS-specific procedures in the 5GC 110 and RAN 150, wireless communication links, etc. remain hidden from the TSN 10. To achieve such transparency to the TSN 10 so that the 5GS 100 appears as any other TSN bridge, the 5GS provides TSN ingress and egress ports via DS-TT 160 and NW-TT 170. DS-TT and NW-TT optionally support hold and forward functionality for the purpose of de-jittering, and per-stream filtering and policing as defined in IEEE 802.1Q, clause 8.6.5.1.

DS-TT 170 optionally supports link layer connectivity discovery and reporting as defined in IEEE 802.1AB for discovery of Ethernet devices attached to DS-TT 170. NW-TT 180 supports link layer connectivity discovery and reporting as defined in IEEE 802.1 AB for discovery of Ethernet devices attached to NW-TT 180. If a DS-TT 170 does not support link layer connectivity discovery and reporting, then NW-TT 180 performs link layer connectivity discovery and reporting as defined in IEEE 802.1 AB for discovery of Ethernet devices attached to DS-TT 170 on behalf of DS-TT 170.

The 5GS 100 supports TSCs. TSC, as defined in TS 23.50, is a communication service that supports deterministic communication and/or isochronous communication with high reliability and availability. Examples of such services are the ones in the area of Industrial Internet of Things (IoT), e.g. related to cyber-physical control applications as described in TS 22.104.

To support strict synchronization accuracy requirements of TSC applications, the base station 155 may signal 5G system time reference information to the UE 160 using unicast or broadcast Radio Resource Control (RRC) signaling with a granularity of 10 ns. An uncertainty parameter may be included in reference time information to indicate its accuracy. The base station 155 may also receive TSC Assistance Information (TSCAI), see TS 23.501, from the 5GC 110, e.g. during Quality of Service (QoS) flow establishment, or from another base station 155 during handover. TSCAI contains additional information about the traffic flow such as burst arrival time and burst periodicity. TSCAI knowledge may be leveraged in the scheduler at the base station 155 to more efficiently schedule periodic, deterministic traffic flows either via configured grants, semi-persistent scheduling or with dynamic grants.

Time reference information for TSC is provided to the UE 160 in system information (SI) as described in 3GPP TS 38.331 v16.0.0. SIB9 contains information related to Global Positioning System (GPS) time and Coordinated Universal Time (UTC). The UE 160 may use the parameters provided in SIB9 to obtain the UTC, the GPS time and the local time. The UE 160 may use the time information for numerous purposes, possibly involving upper layers, e.g., to assist GPS initialization, to synchronize the UE 160 clock.

An exemplary SIB9 information element is shown below. The SIB9 information element includes a field denoted referenceTimelnfo-r16, referred to herein as the 5G time reference, which contains the time reference for TSC.

SIB9 Information Element

| | |
|---|---|
| -- ASN1START | |
| -- TAG-SIB9-START | |
| SIB9::= | SEQUENCE { |
| timeInfo | SEQUENCE { |
| LimeInfoUTC | INTEGER (0..549755813887), |
| dayLightSavingTime | BIT STRING (SIZE (2) ) |
| OPTIONAL, -- Need R | |
| leapSeconds | INTEGER (-127..128) |
| OPTIONAL, -- Need R | |
| localTimeOffset | INTEGER (-63..64) |
| OPTIONAL -- Need R | |
| } | |
| OPTIONAL, -- Need R | |
| lateNonCriticalExtension | OCTET STRING |
| OPTIONAL, | |
| . . . , | |
| [ [ | |
| referenceTimeInfo-r16 | ReferenceTimeInfo-r16 |
| OPTIONAL -- Need R | |
| ] ] | |
| } | |
| -- TAG-SIB9-STOP | |
| -- ASN1STOP | |

SIB9 field descriptions
dayLightSavingTime
Indicates if and how daylight-saving time (DST) is applied to obtain the local time. The semantics are the same as the semantics of the Daylight Saving Time IE in TS 24.501 [23] and TS 24.008 [38]. The first/leftmost bit of the bit string contains the b2 of octet 3 and the second bit of the bit string contains b1 of octet 3 in the value part of the Daylight Saving Time IE in TS 24.008 [38].

leapSeconds
Number of leap seconds offset between GPS Time and UTC. UTC and GPS time are related i.e., GPS time -leapSeconds = UTC time.

localTimeOffset
Offset between UTC and local time in units of 15 minutes. Actual value = field value * 15 minutes. Local time of the day is calculated as UTC time + localTimeOffset.

timelnfoUTC
Coordinated Universal Time corresponding to the SFN boundary at or immediately after the ending boundary of the SI-window in which SIB9 is transmitted. The field counts the number of UTC seconds in 10 ms units since 00:00:00 on Gregorian calendar date 1 January 1900 (midnight between Sunday, December 31, 1899 and Monday, January 1, 1900). See NOTE 1. This field is excluded when determining changes in system information, i.e., changes of timelnfoUTC should neither result in system information change notifications nor in a modification of valueTag in SIB1.

A new feature of New Radio (NR) is on-demand SI. This feature allows the network to only broadcast some of the SI messages when there is a UE 160 that needs to acquire it. The. UE 160 requests such SI messages using either Message 1 (msg1) or Message 3 (msg3) based procedures. The procedure allows a UE 160 to request the needed content on-demand and allows the network to minimize the overhead in constantly broadcasting SI that no UE 160 is currently acquiring.

On-demand SI can also be obtained via RRC signaling. In the RRC on-demand SI framework, the parameter si-BroadcastStatus is used to indicate whether an SI message is currently being broadcast. The si-BroadcastStatus parameter includes a first value to indicate the broadcast status for the SI that is broadcasting (the broadcasting indicator) and a second value to indicate that the broadcast status for the SI that is notBroadcasting (the notBroadcasting indicator). From the UE 160 perspective, independent of whether an SI message is indicated as broadcasting or notBroadcasting, the UE 160 obtains the SI scheduling information for the SI message from SIB1. If an SI message is indicated as broadcasting, the UE 160 can directly acquire the SI message based on the SI scheduling information. However, if an SI message is indicated as notBroadcasting, the UE 160 first needs to perform the on-demand SI request procedure with the base station 155 in order to initiate the transmission of the SI message (according to the SI scheduling information).

Currently, the on-demand broadcast for UEs in RRC_IDLE/INACTIVE state is based upon msg1 and msg3 solutions outlined below:

Broadcast (Msg1 option):
Msg1 SI Request RACH procedure (PRACH, “RAR”)
Broadcast SI message (for some time)
Broadcast (Msg3 option):
Msg3 SI Request RACH procedure (PRACH, RAR, RRCSystemlnfoRequest,
“Msg4”)
Broadcast SI message (for some time)

Additionally, the unicast (dedicated signaling) from IDLE/INACTIVE mode outline below is available in some embodiments.

Unicast (from IDLE/INACTIVE):
Full RACH procedure (PRACH, RAR, RRC Setup/Resume Request, RRC
Setup/Resume)
On-demand request message
Dedicated SI message

For the case of UEs 160 in RRC_CONNECTED state, only certain SIBs can be requested on-demand and the granularity is per SIB. In order to do so, the UE 160 sends a DedicatedSIBRequest message with the requested SIBs and the network may choose to broadcast them or to send them via dedicated signaling in the RRC reconfiguration message.

The on-demand SI procedures currently in use are not adequate to ensure that time reference information for TSC will be provided to the UE 160. 5G reference time information is contained in SIB9, which includes two fields: 1) the timelnfo field and 2) the referenceTimelnfo-r16 field. For TSC, the referenceTimelnfo-r16 field is needed by the UE 160 for synchronization. While the UE 160 in RRC Idle mode or RRC Inactive mode can request SIB9 using existing procedures, both of the time info and referenceTimelnfo-r16 fields are optional so there is no guarantee that the network will deliver what is needed by the UE 160. The UE 160 is unable to indicate what information is required. If the UE 160 does not receive the information needed for TSC, the lack of synchronization between the network and the UE 160 may prevent TSC communication. Even if the UE 160 is able to achieve course synchronization, it may not be able to meet QoS requirements for TSC communications.

According to one aspect of the present disclosure, procedures are introduced to enable the UE 160 to explicitly request, via an on-demand SIB procedure, a time reference needed for TSC. Applying these procedures, the network will signal to the UE 160 the necessary field(s) for enabling time sensitive communications when requested by the UE 160.

In some embodiments, the network sends an explicit indication in order to allow the UE 160 to request on-demand SIB(s) for time sensitive communications. The network will be aware that, if an on-demand request for SIB(s) where time sensitive information is contained, these field related to TSC are expected from the UE 160.

The terms “time reference information” and “5G clock information” as used herein refer to the same field(s)/information and are inter-changeable without any loss of meaning. Further, the embodiments are described in the contest of a NR standalone operation, but the same methods and solutions can be applied in dual connectivity scenarios regardless of the combination of radio access technologies (RATs) between the master node (MN) and the secondary node (SN). Also, those skilled in the art will appreciate that the procedures herein described can be applied to Long Term Evolution (LTE) or any other radio access technology (RAT) that provides 5G reference time information to the UE 160. Also, the concept described herein can be extended to apply to other time references in other RATs.

### Explicit Indication to the Network That 5G Reference Time Information Are Needed

In some embodiments, the UE 160 is configured to explicitly indicate when it needs a time reference for TSC.

In one embodiment, the UE 160 sends an on-demand request for a SIB that contains 5G time reference information. The on-demand request includes, in the same request, an explicit indication that 5G time reference information is needed.

In another embodiment, the UE 160 sends an on-demand request for a SIB that does not contain the 5G time reference information. The on-demand request includes an explicit indication that 5G time reference information is needed.

The explicit indication can take a variety of forms. For example, the indication may comprise one-bit field or flag that is set to a first value (e.g., “true” or “1”) to indicate that 5G time reference information is needed, or a second value (“false” or “0”) to indicate that 5G time reference information is not needed. As another example, the request may contain the name of or other reference to (e.g., index) the field containing the time reference to enable TSC (e.g., the reference Timelnfo-r16).

Upon receiving the explicit request for 5G time reference information, the network sends the requested 5G time reference in either a broadcast message or a dedicated (e.g., unicast) message. In one embodiment, the base station 155 broadcasts the SIB (e.g., SIB9) containing the 5G time reference in a broadcast message. In another embodiment, upon receiving the explicit request for 5G time reference information, the base station 155 sends the requested SIB including the related 5G time reference information via dedicated signaling. In yet another embodiment, upon receiving the explicit request for 5G time reference information, the base station 155 decides to not broadcast the requested SIB but instead sends the related fields for 5G time reference information (and not the whole SIB) to the UE 160 via dedicated signaling. The dedicated message may comprise, for example, a RRC message such as the RRCReconfiguration message, the DLInformationTransfermessage, any other existing RRC message, or a new RRC message.

In another embodiment, if the network receives an on-demand request for a particular SIB with the explicit indication for 5G reference time information, the base station 155 includes the 5G reference time information within the particular SIB. The explicit indication may comprise a flag set to the first value or the name of the field containing the 5G time reference or other reference to the field. Conversely, if the base station 155 receives an on-demand request for a particular SIB without an explicit indication for 5G reference time information (i.e., no flag or reference to a field containing the 5G time reference), the base station 155 sends the requested SIB without including the 5G reference time information.

In one embodiment, upon receiving a request for a SIB containing an explicit indication for 5G time reference information, the base station 155 may decide to not broadcast the requested SIB but instead send the related fields for 5G time reference information (and not the whole SIB) to the UE 160 via dedicated signaling. In another embodiment, upon receiving the request containing an explicit indication for 5G time reference information, the base station 155 can decide to broadcast the requested SIB without the related field for 5G time reference information and send the related fields for 5G time reference information (and not the whole SIB) to the UE 160 via dedicated signaling. The dedicated message may comprise an RRC message such as the RRCReconfiguration message or the DLInformationTransfer, message, any other existing RRC message, or a new RRC message.

In some embodiments, the on-demand feature for requesting the 5G time reference can be selectively enabled or disabled by the base station 155. In one embodiment, the base station 155 sends configuration information to the UE 160 including an explicit indication that on-demand requests for 5G time reference information are allowed. The UE 160 may send an on-demand request for the 5G time reference as needed when allowed by the base station 155.

In one embodiment, the configuration information is contained within the SIB1 and broadcast to the UE 160. In other embodiments, the base station 155 sends the configuration information in a dedicated signaling message. For example, the configuration information can be sent to the UE 160 in the RRCReconfiguration message, the DLInformationTransfer message, any other existing RRC message, or a new RRC message.

In one embodiment, the configuration information may include a one-bit field set to “true” or “1” to indicate that time reference information can be requested on-demand, or set to “false” or “0” to indicate that time reference information cannot be requested. Yet, in another embodiment, the configuration information may contain the explicit name of the needed fields to enable time sensitive communication (e.g., referenceTimelnfo-r16) that can be requested on-demand by the UE 160.

The UE 160, upon receiving the configuration information indicating that on-demand requests for 5G reference time indication are allowed, may send an on-demand request for the SIB(s) containing 5G reference time information as needed. In another embodiment, the UE 160, upon receiving the configuration information indicating that on-demand requests for 5G reference time indication are allowed, sends an on-demand request for SI with an explicit indication that the 5G time reference is needed by the UE 160 for TSC. The explicit indication may comprise a flag or the name or other reference to the fields containing the 5G time reference.

### Network Provides 5G Reference Time Information Responsive to Request For Certain SIBs

In some embodiments, the UE 160 is configured to send an on-demand request for SIB(s) that contains 5G related information when it needs a 5G time reference for TSC. In this case, the base station 155 is configured to always provide the 5G time reference responsive to on-demand requests for certain SIBs.

In one embodiment, upon receiving an on-demand request for SIB(s) that include 5G time reference information, the base station 155 sends the requested SIB and includes the related 5G time reference information via broadcast. In another embodiment, upon receiving the explicit request for 5G time reference information, the base station 155 sends the requested SIB including the related 5G time reference information via dedicated signaling.

In one embodiment, upon receiving the request for the SIB containing the 5G time reference information, the base station 155 may decide to not broadcast the requested SIB but instead to send the related fields for 5G time reference information (and not the whole SIB) to the UE 160 via dedicated signaling. In another embodiment, upon receiving the request for the SIB containing 5G time reference information, the base station 155 decides to broadcast the requested SIB without the related field for 5G time reference information and to send the related fields for 5G time reference information (and not the whole SIB) to the UE 160 via dedicated signaling. The dedicated message may comprise an RRC message such as the RRCReconfiguration message or the DLInformationTransfer, message, any other existing RRC message, or a new RRC message.

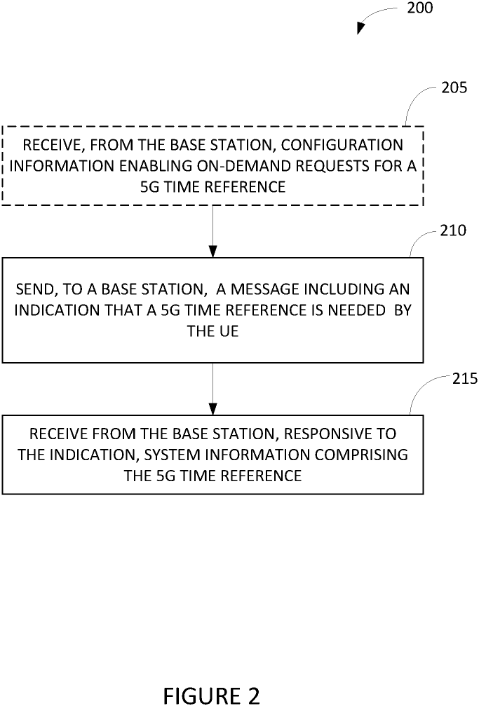

FIG. 2 illustrates an exemplary method 200 implemented by a UE 160 for obtaining a 5G time reference for TSC according to a first embodiment. The method 200 optionally comprises receiving, by the UE 160, configuration information from a base station 155 enabling on-demand requests for the 5G time reference (block 205). The method 200 comprises sending, to a base station, a message including an indication that a 5G time reference is needed by the UE (block 210) and receiving from the base station, responsive to the indication, system information comprising the 5G time reference (block 215).

In some embodiments of the method 200, the message comprises an on-demand request for a specific system information block containing the 5G time reference and/or on-demand system information comprising the 5G time reference.

In some embodiments of the method 200, wherein the system information comprising the 5G time reference is received in SIB9.

In some embodiments of the method 200, the indication comprises a flag set to a first predetermined value.

In some embodiments of the method 200, the indication comprises a reference to a specific element of system information that contains the 5G time reference.

In some embodiments of the method 200, receiving the system information comprising the 5G time reference comprises receiving the 5G time reference in a broadcast message.

In some embodiments of the method 200, the broadcast message includes a system information block (SIB) containing the 5G time reference.

In some embodiments of the method 200, receiving the system information comprising the 5G time reference comprises receiving the 5G time reference in a dedicated message.

In some embodiments of the method 200, receiving the system information comprising the 5G time reference comprises receiving at least a portion of the system information in a broadcast message without the 5G time reference being included, and receiving the 5G time reference in a dedicated message.

In some embodiments of the method 200, the dedicated message comprises a radio resource control (RRC) message.

In some embodiments of the method 200, wherein the 5G time reference is for TSC.

Some embodiments of the method 200 further comprise, before sending the message to the base station, receiving from the base station, configuration information enabling on-demand requests for the 5G time reference.

In some embodiments of the method 200, the configuration information comprises a flag set to a first predetermined value.

In some embodiments of the method 200, the configuration information comprises a reference to a specific element of system information that contains the 5G time reference.

In some embodiments of the method 200, receiving the configuration information enabling on-demand requests for a 5G time reference comprises receiving the configuration information in a broadcast message.

In some embodiments of the method 200, the broadcast message comprises a system information block.

In some embodiments of the method 200, receiving the configuration information enabling on-demand requests for a 5G time reference comprises receiving the configuration information in a dedicated message.

In some embodiments of the method 200, receiving the configuration information in a dedicated message comprises receiving the configuration information in a radio resource control (RRC) message.

In some embodiments of the method 200, the RRC message comprises one of a reconfiguration (RRCReconfiguration) message or a downlink (DL) information transfer (DLInformationTransfer) message.

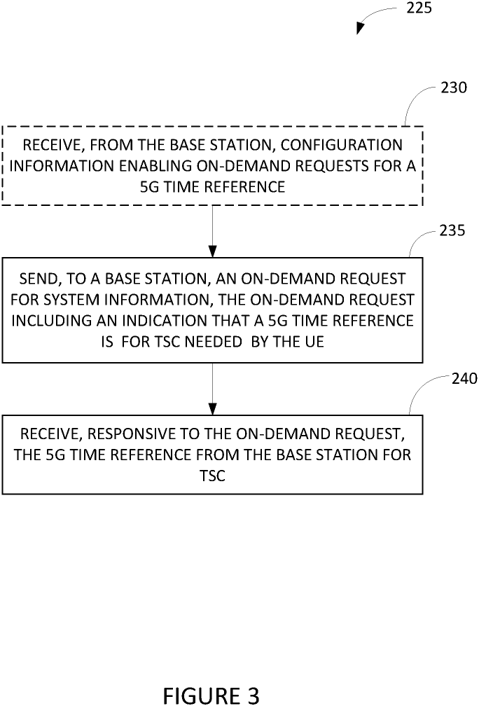

FIG. 3 illustrates an exemplary method 225 implemented by a UE 160 for obtaining a 5G time reference for TSC according to a second embodiment. The method 225 optionally comprises receiving, by the UE 160, configuration information from a base station 155 enabling on-demand requests for the 5G time reference (block 230). The method 225 comprises sending, to the base station 155, an on-demand request for SI. The on-demand request includes an indication that a 5G time reference for TSC is needed by the UE 160 (block 235). The method 200 further comprises receiving, responsive to the on-demand request, the 5G time reference from the base station 155 for TSC (block 240).

In some embodiments of the method 225, the on-demand request is for a specific SIB containing time information.

In some embodiments of the method 225, the on-demand request is for SIB9.

In some embodiments of the method 200, the indication comprises a flag set to a first predetermined value.

In some embodiments of the method 225, the indication comprises a reference to a specific element of system information that contains the 5G time reference.

In some embodiments of the method 225, receiving the 5G time reference comprises receiving the 5G time reference in a broadcast message.

In some embodiments of the method 225, the broadcast message includes a system information block (SIB) containing the 5G time reference.

In some embodiments of the method 225, receiving the 5G time reference comprises receiving the 5G time reference in a dedicated message.

In some embodiments of the method 225, receiving the 5G time reference comprises receiving at least a portion of the system formation in a broadcast message without the 5G time reference being included and receiving the 5G time reference in a dedicated message.

In some embodiments of the method 225, the dedicated message comprises a radio resource control (RRC) message.

In some embodiments of the method 225, the RRC message comprises one of a reconfiguration (RRCReconfiguration) message or a downlink (DL) information transfer (DLInformationTransfer) message.

Some embodiments of the method 225 further comprise sending, to the base station, a second request for system information without an indication that a 5G time reference is needed by the UE for TSC and receiving, responsive to the second on-demand request, system information not including the 5G time reference.

In some embodiments of the method 225, the second on-demand request includes the flag set to a second predetermined value.

In some embodiments of the method 225, the second on-demand request omits the reference to a specific element of system information that contains the 5G time reference.

In some embodiments of the method 225, the second on-demand request is for a system information block that includes the 5G time reference and the UE receives the on-demand requested system information block without the 5G time reference.

Some embodiments of the method 225 further comprise g, before sending the on-demand request to the base station receiving, from the base station, configuration information enabling on-demand requests for the 5G time reference.

In some embodiments of the method 225, the configuration information comprises a flag set to a first predetermined value.

In some embodiments of the method 225, the configuration information comprises a reference to a specific element of system information that contains the 5G time reference.

In some embodiments of the method 225, receiving the configuration information enabling on-demand requests for a 5G time reference for TSC comprises receiving the configuration information in a broadcast message.

In some embodiments of the method 225, the broadcast message comprises a system information block.

In some embodiments of the method 225, receiving the configuration information enabling on-demand requests for a 5G time reference for TSC comprises receiving the configuration information in a dedicated message.

In some embodiments of the method 225, receiving the configuration information in a dedicated message comprises receiving the configuration information in a radio resource control (RRC) message.

In some embodiments of the method 225, the RRC message comprises one of a reconfiguration (RRCReconfiguration) message or a downlink (DL) information transfer (DLInformationTransfer) message.

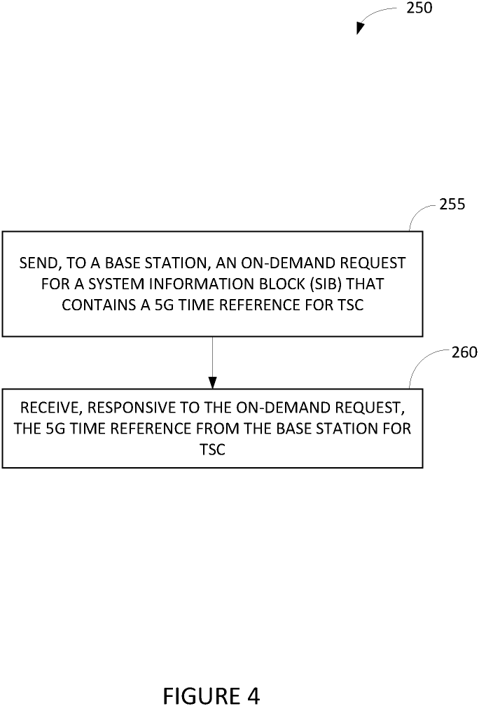

FIG. 4 illustrates an exemplary method 250 implemented by a UE 160 for obtaining a 5G time reference for TSC according to a third embodiment. The method 240 comprises sending, to a base station 155, an on-demand request for a SIB (SIB) that contains a 5G time reference for TSC (block 255). The method 250 further comprises receiving, responsive to the on-demand request, the 5G time reference for TSC from the base station 155 (block 260).

In some embodiments of the method 250, the on-demand request is for SIB9.

In some embodiments of the method 250, receiving the 5G time reference comprises receiving the 5G time reference in a broadcast message.

In some embodiments of the method 250, the broadcast message comprises the system information block (SIB) containing the 5G time reference.

In some embodiments of the method 250, receiving the 5G time reference comprises receiving the 5G time reference in a dedicated message.

In some embodiments of the method 250, receiving the 5G time reference comprises receiving the requested system information block in a broadcast message without the 5G time reference being included and receiving the 5G time reference in a dedicated message.

In some embodiments of the method 250, the dedicated message comprises a radio resource control (RRC) message.

Some embodiments of the method 250 further comprise one of a reconfiguration (RRCReconfiguration) message or a downlink (DL) information transfer (DLInformationTransfer) message.

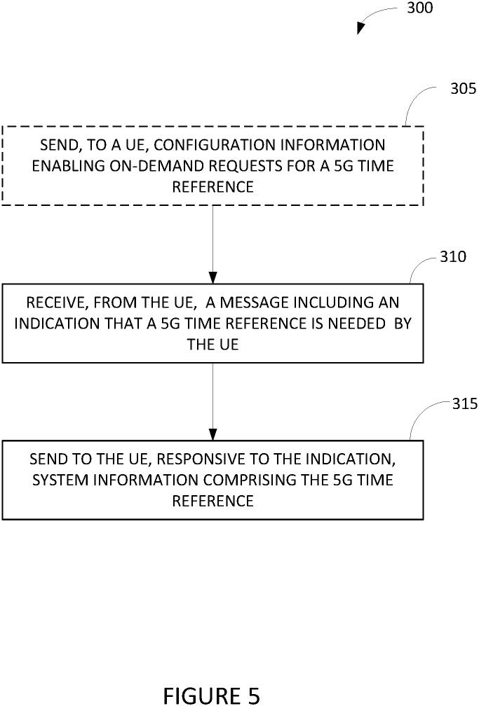

FIG. 5 illustrates an exemplary method 300 implemented by a base station 155 for providing a 5G time reference for TSC according to a first embodiment. The method 300 optionally comprises sending, to the UE 160, configuration information from a base station 155 enabling on-demand requests for the 5G time reference (block 310). The method 300 comprises receiving, from the UE, a message including an indication that a 5G time reference is needed by the UE (block 205). The method further comprises sending to the UE, responsive to the indication, system information comprising the 5G time reference.

In some embodiments of the method 300, the message comprises an on-demand request for a specific system information block containing the 5G time reference and/or on-demand system information comprising the 5G time reference.

In some embodiments of the method 300, the on-demand request is for SIB9.

In some embodiments of the method 300, the indication comprises a flag set to a first predetermined value.

In some embodiments of the method 300, the indication comprises a reference to a specific element of system information that contains the 5G time reference.

In some embodiments of the method 300, sending the system information comprising the 5G time reference comprises sending the 5G time reference in a broadcast message.

In some embodiments of the method 300, the broadcast message includes a system information block (SIB) containing the 5G time reference.

In some embodiments of the method 300, sending the system information comprising the 5G time reference comprises sending the 5G time reference in a dedicated message.

In some embodiments of the method 300, sending the system information comprising the 5G time reference comprises sending at least a portion of the system formation in a broadcast message without the 5G time reference being included, and sending the 5G time reference in a dedicated message.

In some embodiments of the method 300, the dedicated message comprises a radio resource control (RRC) message.

In some embodiments of the method 300, the 5G time reference is for TSC.

Some embodiments of the method 300 further comprise, before sending the message to the base station, sending configuration information to the UE enabling on-demand requests for the 5G time reference.

In some embodiments of the method 300, the configuration information comprises a flag set to a first predetermined value.

In some embodiments of the method 300, the configuration information comprises a reference to a specific element of system information that contains the 5G time reference.

In some embodiments of the method 300, sending the configuration information enabling on-demand requests for a 5G time reference comprises receiving the configuration information in a broadcast message.

In some embodiments of the method 300, the broadcast message comprises a system information block.

In some embodiments of the method 300, sending the configuration information enabling on-demand requests for a 5G time reference comprises receiving the configuration information in a dedicated message.

In some embodiments of the method 300, sending the configuration information in a dedicated message comprises receiving the configuration information in a radio resource control (RRC) message.

In some embodiments of the method 300, the RRC message comprises one of a reconfiguration (RRCReconfiguration) message or a downlink (DL) information transfer (DLInformationTransfer) message.

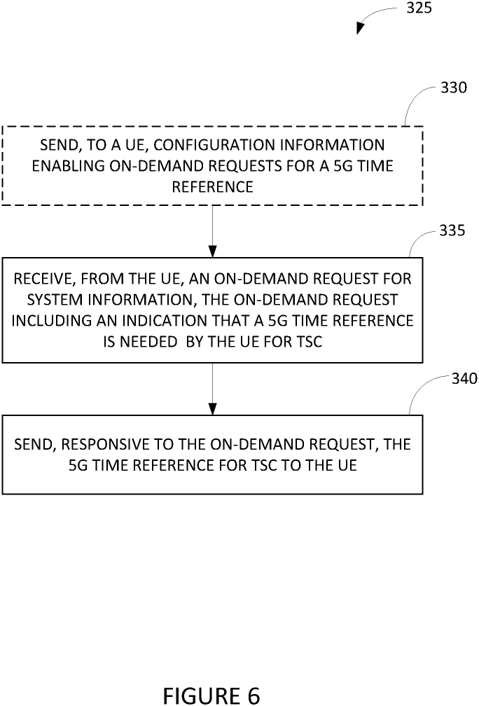

FIG. 6 illustrates an exemplary method 325 implemented by a base station 155 for providing a 5G time reference for TSC according to a second embodiment. The method 300 optionally comprises sending, to the UE 160, configuration information from a base station 155 enabling on-demand requests for the 5G time reference (block 330). The method 325 comprises receiving, from the UE 160, an on-demand request for SI (block 335). The on-demand request includes an indication that a 5G time reference is needed by the UE 160 for TSC. The method 300 further comprises sending, responsive to the on-demand request, the 5G time reference for TSC to the UE 160 (block 340).

In some embodiments of the method 300, the on-demand request is for a specific system information block containing time information.

In some embodiments of the method 325, the on-demand request is for SIB9.

In some embodiments of the method 325, the indication comprises a flag set to a first predetermined value.

In some embodiments of the method 325, the indication comprises a reference to a specific element of system information that contains the 5G time reference.

In some embodiments of the method 325, sending the 5G time reference comprises sending the 5G time reference in a broadcast message.

In some embodiments of the method 325, the broadcast message includes a system information block (SIB) containing the 5G time reference.

In some embodiments of the method 325, sending the 5G time reference comprises sending the 5G time reference in a dedicated message.

In some embodiments of the method 325, sending the 5G time reference comprises sending at least a portion of the system formation in a broadcast message without the 5G time reference being included and sending the 5G time reference in a dedicated message.

In some embodiments of the method 325, the dedicated message comprises a radio resource control (RRC) message.

In some embodiments of the method 325, the RRC message comprises one of a reconfiguration (RRCReconfiguration) message or a downlink (DL) information transfer (DLInformationTransfer) message.

Some embodiments of the method 325 further comprise receiving, from the UE a second request for system information without an indication that a 5G time reference is needed by the UE for TSC and sending, responsive to the second on-demand request, system information not including the 5G time reference.

In some embodiments of the method 325, the second on-demand request includes the flag set to a second predetermined value.

In some embodiments of the method 325, the second on-demand request omits the reference to a specific element of system information that contains the 5G time reference.

In some embodiments of the method 325, the second on-demand request is for a system information block that includes the 5G time reference and the base station sends the on-demand requested system information block without the 5G time reference.

Some embodiments of the method 325 further comprise, before sending the on-demand request to the base station sending, to the UE, configuration information enabling on-demand requests for the 5G time reference.

In some embodiments of the method 325, the configuration information comprises a flag set to a first predetermined value.

In some embodiments of the method 325, the configuration information comprises a reference to a specific element of system information that contains the 5G time reference.

In some embodiments of the method 325, sending the configuration information enabling on-demand requests for a 5G time reference for TSC comprises sending the configuration information in a broadcast message.

In some embodiments of the method 325, the broadcast message comprises a system information block.

In some embodiments of the method 325, sending the configuration information enabling on-demand requests for a 5G time reference for TSC comprises receiving the configuration information in a dedicated message.

In some embodiments of the method 325, sending the configuration information in a dedicated message comprises receiving the configuration information in a radio resource control (RRC) message.

In some embodiments of the method 325, the RRC message comprises one of a reconfiguration (RRCReconfiguration) message or a downlink (DL) information transfer (DLInformationTransfer) message.

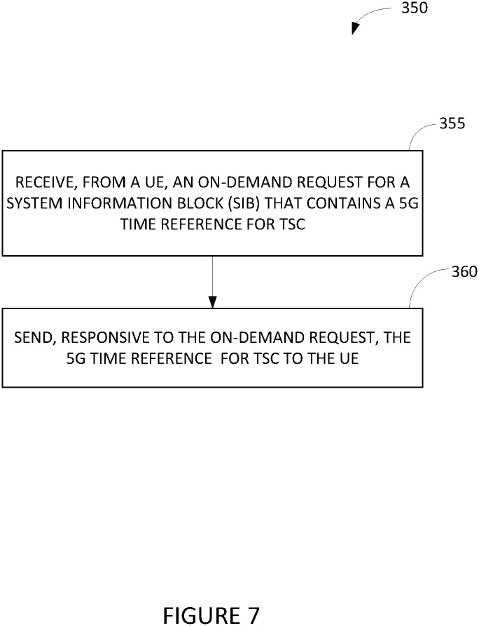

FIG. 7 illustrates an exemplary method 350 implemented by a base station 155 for providing a 5G time reference for TSC according to a third embodiment. The method comprises receiving, from the UE 160, an on-demand request for a SIB (SIB) that contains a 5G time reference for TSC (block 350). The method 350 further comprises sending, responsive to the on-demand request, the 5G time reference for TSC to the UE 160 (block 360).

In some embodiments of the method 350, the on-demand request is for SIB9.

In some embodiments of the method 350, receiving the 5G time reference comprises receiving the 5G time reference in a broadcast message.

In some embodiments of the method 350, the broadcast message comprises the system information block (SIB) containing the 5G time reference.

In some embodiments of the method 350, sending the 5G time reference comprises receiving the 5G time reference in a dedicated message.

In some embodiments of the method 350, sending the 5G time reference comprises sending the requested system information block in a broadcast message without the 5G time reference being included and sending the 5G time reference in a dedicated message.

In some embodiments of the method 350, the dedicated message comprises a radio resource control (RRC) message.

In some embodiments of the method 350, the RRC message comprises one of a reconfiguration (RRCReconfiguration) message or a downlink (DL) information transfer (DLInformationTransfer) message.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

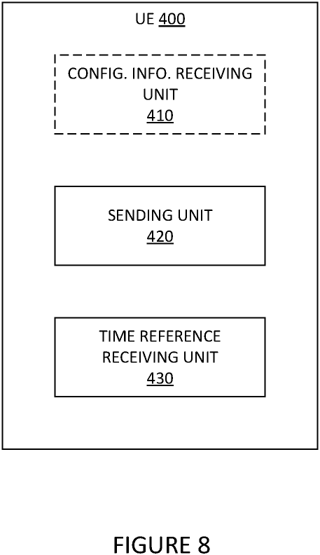

FIG. 8 illustrates an exemplary UE 400 configured for obtaining a 5G time reference for TSC according to a first embodiment. The UE 400 comprises an optional configuration information receiving unit 410, a sending unit 420, and time reference receiving unit 430. The various units 410-430 can be implemented by hardware and/or by software code that is executed by one or more processors or processing circuits. The configuration information receiving unit 410, when present, is configured to receive, from the base station, configuration information enabling on-demand requests for a 5G time reference for TSC. The sending unit 420 is configured to send, to the base station, a message including an indication that a 5G time reference is needed by the UE. As one example, the 5G time reference may be needed for TSC. The time reference receiving unit 430 is configured to receive, responsive to the indication, system information comprising the 5G time reference from the base station for TSC. In some embodiments, the message comprises an on-demand request for a specific information block containing the 5G time reference. In other embodiments, the message comprises a request for on-demand system information comprising the 5G time reference.

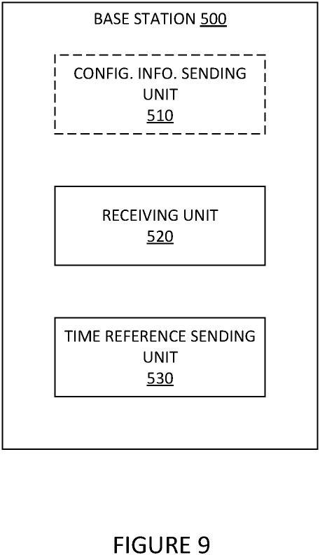

FIG. 9 illustrates an exemplary base station 500 for providing a 5G time reference for TSC according to a first embodiment. The base station 500 comprises an optional configuration information sending unit 510, a receiving unit 520, and a time reference sending unit 530. The various units 510-530 can be implemented by hardware and/or by software code that is executed by one or more processors or processing circuits. The configuration information sending unit 510, when present, is configured to send, to a UE, configuration information enabling on-demand requests for a 5G time reference for TSC. The receiving unit 520 is configured to receive, from the UE, a message including an indication that a 5G time reference is needed by the UE for TSC. The time reference sending unit 530 is configured to send, responsive to the indication, system information comprising the 5G time reference for TSC to the UE 160. In some embodiments, the message comprises an on-demand request for a specific information block containing the 5G time reference. In other embodiments, the message comprises a request for on-demand system information comprising the 5G time reference.

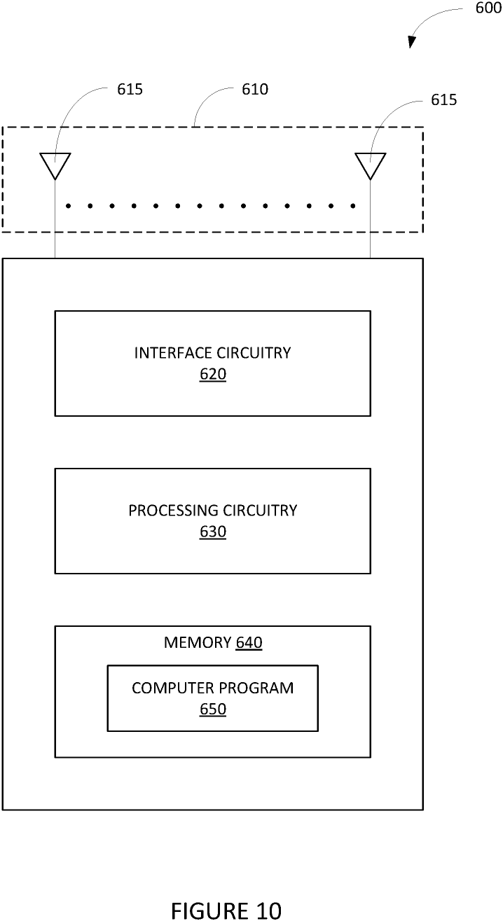

FIG. 10 illustrates the main functional components of a UE 600 configured to operate as herein described. The UE 600 comprises an antenna array 610 with multiple antenna elements 615, an interface circuitry 620, a processing circuitry 630, and memory 640.

The interface circuitry 620 is coupled to the antennas 615 and comprises the radio frequency (RF) circuitry needed for communicating over a wireless communication channel with base stations 155 in a wireless communication network. The interface circuitry 620 may, for example, comprise a transmitter and receiver configured to operate according to the NR standard.

The processing circuitry 630 controls the overall operation of the UE 600 and implements the procedures and methods as herein described for obtaining a time reference for TSC. The processing circuitry 630 may comprise one or more microprocessors, hardware, firmware, or a combination thereof. The processing circuitry 630 is configured to implement one or more of the methods 200, 225 and 250 according to FIGS. 2-4 respectively

Memory 640 comprises both volatile and non-volatile memory for storing computer program code and data needed by the processing circuitry 630 for operation. Memory 640 may comprise any tangible, non-transitory computer-readable storage medium for storing data including electronic, magnetic, optical, electromagnetic, or semiconductor data storage. Memory 640 stores computer programs 650 comprising executable instructions that configure the processing circuitry 630 to implement one or more of the methods 200, 225 and 250 according to FIGS. 2 - 4 respectively as described herein. A computer program 650 in this regard may comprise one or more code modules corresponding to the functional units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 650 for configuring the processing circuitry 630 as herein described may be stored in a removable memory, such as a portable compact disc, portable digital video disc, or other removable media. The computer program 650 may also be embodied in a carrier such as an electronic signal, optical signal, radio signal, or computer readable storage medium.

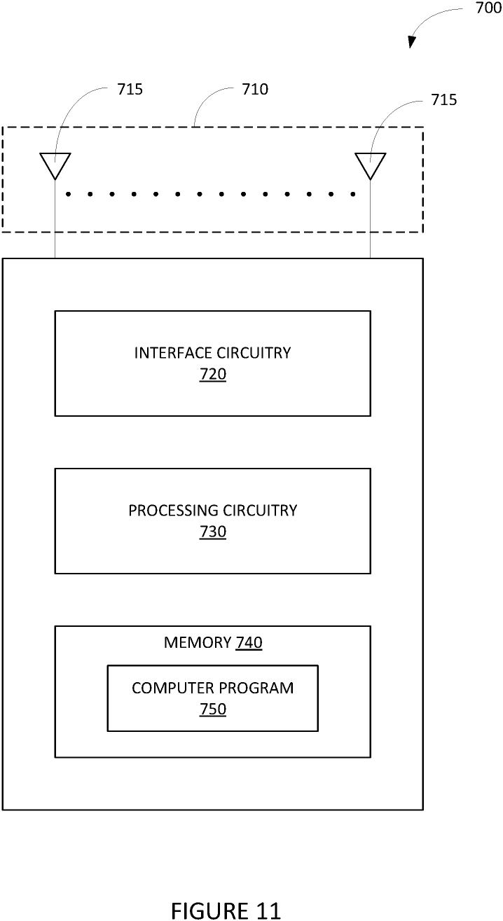

FIG. 11 illustrates the main functional components of a base station 700 configured to operate as herein described. The base station 700 comprises an antenna array 710 with multiple antenna elements 715, an interface circuit 720, a processing circuit 730, and memory 740.

The interface circuitry 720 is coupled to the antennas 715 and comprises the radio frequency (RF) circuitry needed for communicating over a wireless communication channel with UEs 160 in a wireless communication network. The interface circuitry 620 may, for example, comprise a transmitter and receiver configured to operate according to the NR standard.

The processing circuitry 730 controls the overall operation of the base station 700 and implements the procedures and methods as herein described for obtaining a time reference for TSC. The processing circuitry 730 may comprise one or more microprocessors, hardware, firmware, or a combination thereof. The processing circuit 730 is configured to implement one or more of the methods 300, 325 and 350 according to FIGS. 5 - 7.

Memory 740 comprises both volatile and non-volatile memory for storing computer program code and data needed by the processing circuitry 730 for operation. Memory 740 may comprise any tangible, non-transitory computer-readable storage medium for storing data including electronic, magnetic, optical, electromagnetic, or semiconductor data storage. Memory 740 stores computer programs 750 comprising executable instructions that configure the processing circuitry 730 to implement one or more of the methods 300, 325 and 350 according to FIGS. 5 - 7 respectively as described herein. A computer program 750 in this regard may comprise one or more code modules corresponding to the functional units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 750 for configuring the processing circuitry 730 as herein described may be stored in a removable memory, such as a portable compact disc, portable digital video disc, or other removable media. The computer program 750 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

The methods and solutions herein described allow the UE to explicitly request via the on-demand SIB procedure the time reference information needed to enable TSC. The network will be aware on what fields need to be signaled in order to enable 5G synchronization for TSC and will provide the required time reference information to the UE.

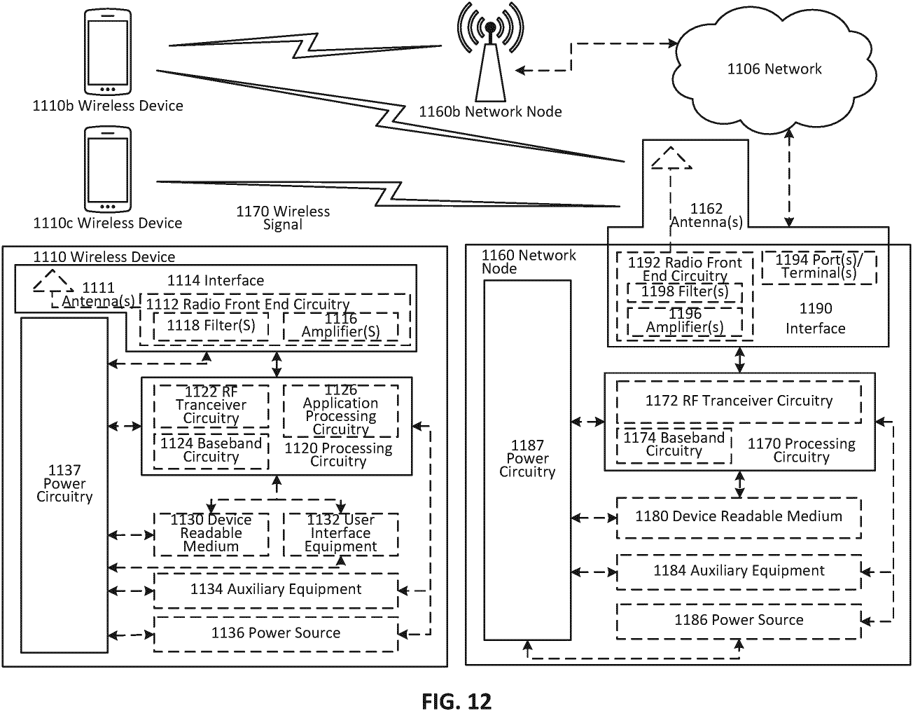

Although the subject matter described herein may be implemented in any appropriate type of system using any suitable components, the embodiments disclosed herein are described in relation to a wireless network, such as the example wireless network illustrated in FIG. 12. For simplicity, the wireless network of FIG. 12 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices’ access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 12, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 12 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB’s. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 12 that may be responsible for providing certain aspects of the network node’s functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2l), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

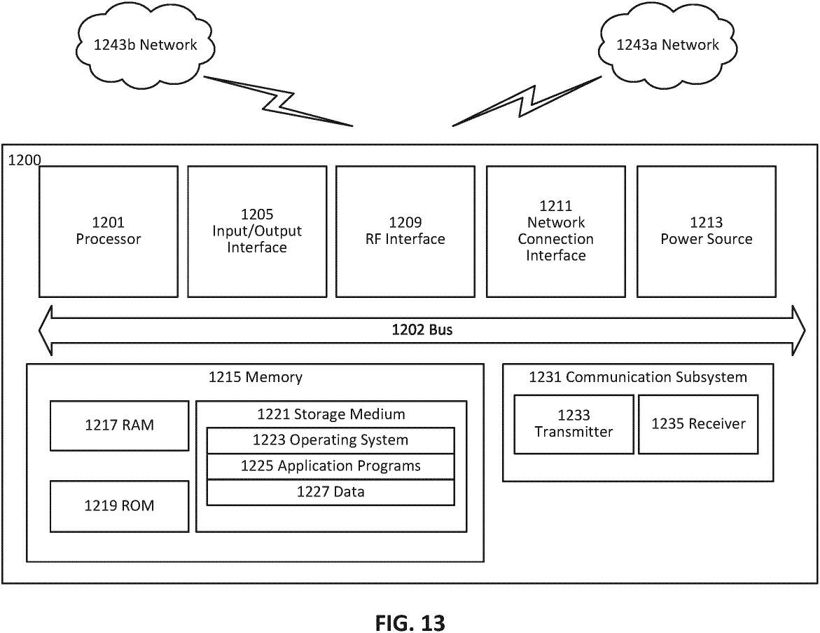

FIG. 13 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 13, is one example of a WD configured for communication in accordance with one or more communication standards promulgated by the 3^{rd} Generation Partnership Project (3GPP), such as 3GPP’s GSM, UMTS, LTE, and/or 5G standards. As mentioned previously, the term WD and UE may be used interchangeable. Accordingly, although FIG. 13 is a UE, the components discussed herein are equally applicable to a WD, and vice-versa.

In FIG. 13, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 13, or only a subset of the components. The level of integration between the components may vary from one UE to another UE. Further, certain UEs may contain multiple instances of a component, such as multiple processors, memories, transceivers, transmitters, receivers, etc.

In FIG. 13, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 13, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 13, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.17, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

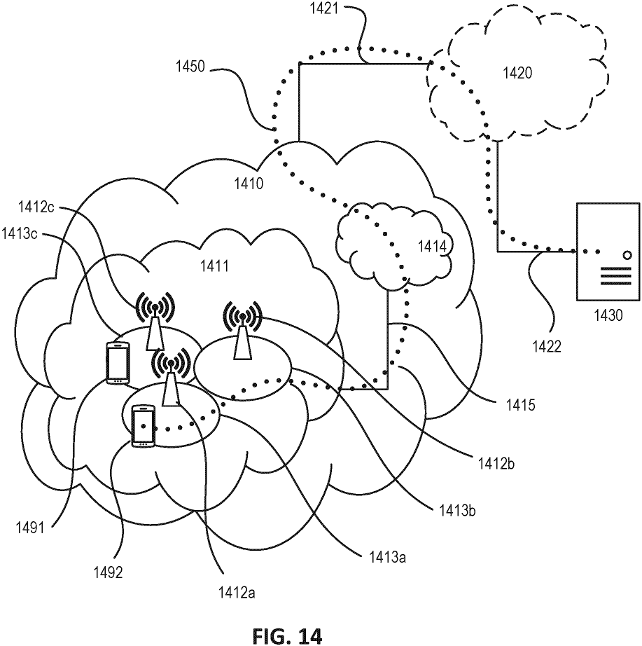

FIG. 14 illustrates a telecommunication network connected via an intermediate network to a host computer in accordance with some embodiments. In particular, with reference to FIG. 14, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 14 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

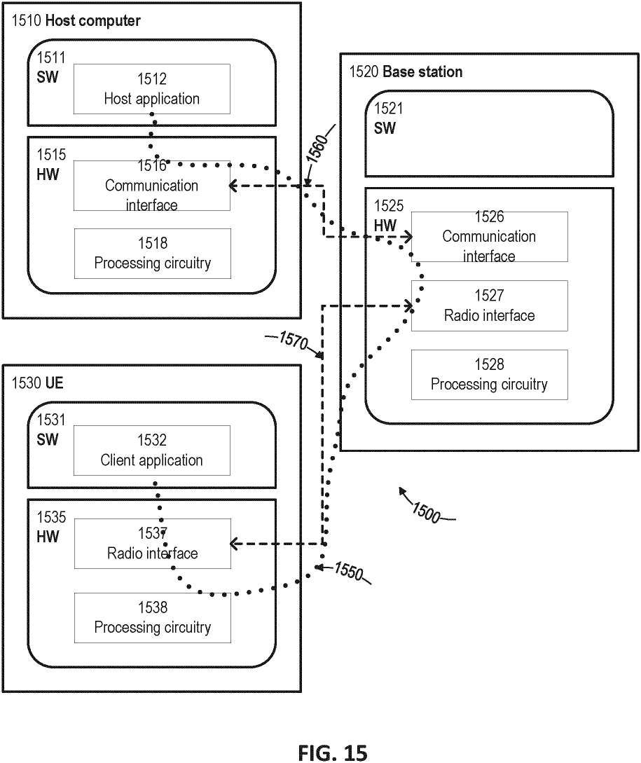

Example implementations, in accordance with an embodiment, of the UE, base station and host computer discussed in the preceding paragraphs will now be described with reference to FIG. 15. FIG. 15 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 15) served by base station 1520. Communication interface 1526 may be configured to facilitate connection 1560 to host computer 1510. Connection 1560 may be direct or it may pass through a core network (not shown in FIG. 15) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 15 may be similar or identical to host computer 1430, one of base stations 1412a, 1412b, 1412c and one of UEs 1491, 1492 of FIG. 14, respectively. This is to say, the inner workings of these entities may be as shown in FIG. 15 and independently, the surrounding network topology may be that of FIG. 14.

In FIG. 15, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments provide methods for on-demand acquisition of timing information for TSC and thereby provide benefits such as very low latency for TSC.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510′s measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

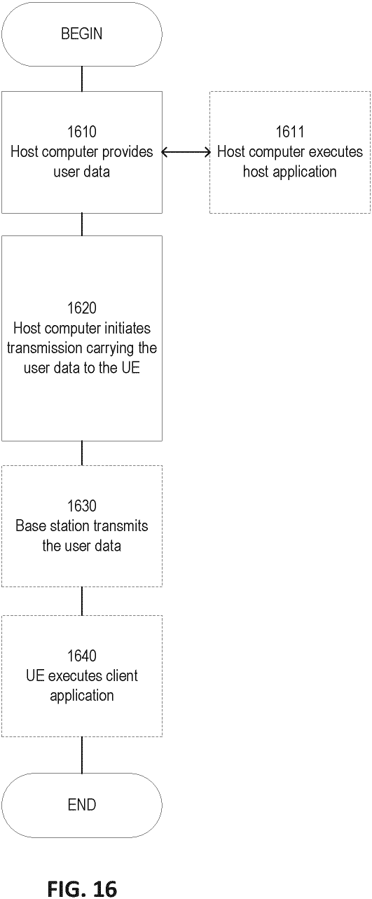

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

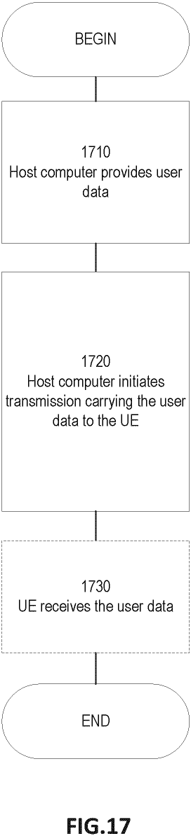

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

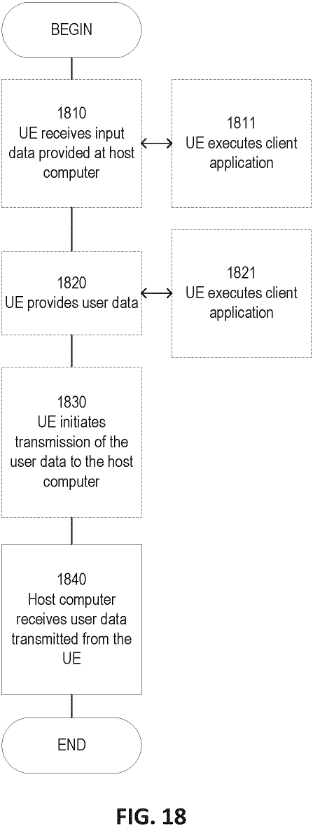

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

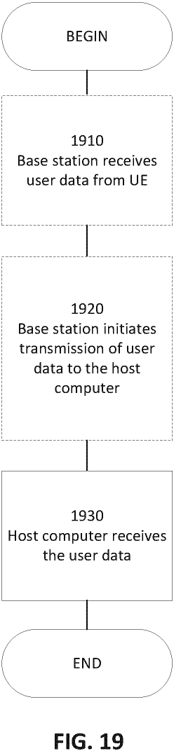

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

### ADDITIONAL EMBODIMENTS

Exemplary embodiments of the disclosure are enumerated below which are divided into groups denoted as Group A - Group E. Dependent dependent in a group refer to earlier embodiments in the same group.

### Group a Embodiments

1. A method implemented by a user equipment (UE) of obtaining time information for time-sensitive communications (TSC), the method comprising:
sending, to a base station, an on-demand request for system information, the on-demand request including an indication that a 5G time reference is needed by the UE for TSC; and
receiving, responsive to the on-demand request, the 5G time reference from the base station for TSC.

2. The method of embodiment 1, wherein, the on-demand request is for a specific system information block containing time information.

3. The method of embodiment 2 wherein, the on-demand request is for SIB9.

4. The method of any one of embodiments 1 - 3 wherein, the indication comprises a flag set to a first predetermined value.

5. The method of any one of embodiments 1 - 3 wherein, the indication comprises a reference to a specific element of system information that contains the 5G time reference.

6. The method of any one of embodiments 1 - 5 wherein, receiving the 5G time reference comprises receiving the 5G time reference in a broadcast message.

7. The method of embodiment 6 wherein, the broadcast message includes a system information block (SIB) containing the 5G time reference.

8. The method of any one of embodiments 1 - 5 wherein, receiving the 5G time reference comprises receiving the 5G time reference in a dedicated message.

9. The method of claim 8 wherein receiving the 5G time reference comprises:
receiving at least a portion of the system formation in a broadcast message without the 5G time reference being included; and
receiving the 5G time reference in a dedicated message.

10. The method of embodiment 8 or 9 wherein, the dedicated message comprises a radio resource control (RRC) message.

11 The method of embodiment 8 or 9 wherein, the RRC message comprises one of a reconfiguration (RRCReconfiguration) message or a downlink (DL) information transfer (DLInformationTransfer) message.

12. The method of any one of embodiments 1-11 further comprising:
sending, to the base station, a second request for system information without an indication that a 5G time reference is needed by the UE for TSC; and
receiving, responsive to the second on-demand request, system information not including the 5G time reference.

13. The method of embodiment 12 wherein the second on-demand request includes the flag set to a second predetermined value.

14. The method of embodiment 12 wherein the second on-demand request omits the reference to a specific element of system information that contains the 5G time reference.

15. The method of any one of embodiments 12-14 wherein:
the second on-demand request is for a system information block that includes the 5G time reference; and
the UE receives the on-demand requested system information block without the 5G time reference.

16. The method of any one of embodiments 1-15 further comprising, before sending the on-demand request to the base station:

receiving, from the base station, configuration information enabling on-demand requests for the 5G time reference.

17. A method implemented by a user equipment (UE) of obtaining time information for time-sensitive communications (TSC), the method comprising:
sending, to a base station, an on-demand request for a system information block (SIB) that contains a 5G time reference for TSC; and
receiving, responsive to the on-demand request, the 5G time reference from the base station for TSC.

18. The method of embodiment 17 wherein, the on-demand request is for SIB9.

19. The method of embodiment 17 or 18 wherein, receiving the 5G time reference comprises receiving the 5G time reference in a broadcast message.

20. The method of embodiment 19 wherein, the broadcast message comprises the system information block (SIB) containing the 5G time reference.

21. The method of embodiment 17 or 18 wherein, receiving the 5G time reference comprises receiving the 5G time reference in a dedicated message.

22. The method of claim 21 wherein receiving the 5G time reference comprises:
receiving the requested system information block in a broadcast message without the 5G time reference being included; and
receiving the 5G time reference in a dedicated message.

23. The method of embodiment 21 or 22 wherein, the dedicated message comprises a radio resource control (RRC) message.

24. The method of claim 23 wherein, RRC message comprises one of a reconfiguration (RRCReconfiguration) message or a downlink (DL) information transfer (DLInformationTransfer) message.

25. A method implemented by a user equipment (UE) of obtaining time information for time-sensitive communications (TSC), the method comprising:
receiving, from the base station, configuration information enabling on-demand requests for a 5G time reference for TSC; and
sending, to the base station, an on-demand request for system information, the on-demand request including an indication that a 5G time reference is needed by the UE for TSC.

26. The method of embodiment 25 wherein, the configuration information comprises a flag set to a first predetermined value.

27. The method of embodiment 25 wherein, the configuration information comprises a reference to a specific element of system information that contains the 5G time reference.

28. The method of any one of embodiments 25 - 27 wherein, receiving the configuration information enabling on-demand requests for a 5G time reference for TSC comprises receiving the configuration information in a broadcast message.

29. The method of embodiment 28 wherein, the broadcast message comprises a system information block.

30. The method of any one of embodiments 25 - 27 wherein, receiving the configuration information enabling on-demand requests for a 5G time reference for TSC comprises receiving the configuration information in a dedicated message.

31. The method of embodiment 25 wherein, receiving the configuration information in a dedicated message comprises receiving the configuration information in a radio resource control (RRC) message.

32. The method of claim 28 wherein, the RRC message comprises one of a reconfiguration (RRCReconfiguration) message or a downlink (DL) information transfer (DLInformationTransfer) message.

### Group B Embodiments

1. A method implemented by a base station of time information for time-sensitive communications (TSC) to a user equipment (UE), the method comprising:
receiving, from the UE an on-demand request for system information, the on-demand request including an indication that a 5G time reference is needed by the UE for TSC; and
sending, responsive to the on-demand request, the 5G time reference for TSC to the UE.

2. The method of embodiment 1, wherein, the on-demand request is for a specific system information block containing time information.

3. The method of embodiment 2 wherein, the on-demand request is for SIB9.

4. The method of any one of embodiments 1 - 3 wherein, the indication comprises a flag.

5. The method of any one of embodiments 1 - 3 wherein, the indication comprises a reference to a specific element of system information that contains the 5G time reference.

6. The method of any one of embodiments 1 - 5 wherein, sending the 5G time reference comprises sending the 5G time reference in a broadcast message.

7. The method of embodiment 6 wherein, the broadcast message includes a system information block (SIB) containing the 5G time reference.

8. The method of any one of embodiments 1 - 5 wherein, sending the 5G time reference comprises sending the 5G time reference in a dedicated message.

9. The method of claim 8 wherein receiving the 5G time reference comprises:
receiving at least a portion of the system formation in a broadcast message without the 5G time reference being included; and
receiving the 5G time reference in a dedicated message.

10. The method of embodiment 8 or 9 wherein, the dedicated message comprises a radio resource control (RRC) message.

11. The method of claim 8 or 9 wherein, the RRC message comprises one of a reconfiguration (RRCReconfiguration) message or a downlink (DL) information transfer (DLInformationTransfer) message.

12. The method of any one embodiments 1-11 further comprising:
receiving, from the UE a second request for system information without an indication that a 5G time reference is needed by the UE for TSC; and
sending, responsive to the second on-demand request, system information not including the 5G time reference.

13. The method of embodiment 12 wherein the second on-demand request includes the flag set to a second predetermined value.

14. The method of embodiment 12 wherein the second on-demand request omits the reference to a specific element of system information that contains the 5G time reference.

15. The method of any one of embodiments 12-14 wherein:
the second on-demand request is for a system information block that includes the 5G time reference; an
the base station sends the on-demand requested system information block without the 5G time reference.

16. The method of any one of embodiments 1-15 further comprising, before sending the on-demand request to the base station:

sending, to the UE, configuration information enabling on-demand requests for the 5G time reference.

17. A method implemented by a base station of providing time information to a user equipment (UE) for time-sensitive communications (TSC), the method comprising:
receiving, from the UE, an on-demand request for a system information block (SIB) that contains a 5G time reference for TSC; and
sending, responsive to the on-demand request, the 5G time reference for TSC to the UE.

18. The method of embodiment 17 wherein, the on-demand request is for SIB9.

19. The method of embodiment 17 or 18 wherein, receiving the 5G time reference comprises receiving the 5G time reference in a broadcast message.

20 The method of embodiment 19 wherein, the broadcast message comprises the system information block (SIB) containing the 5G time reference.

21. The method of embodiment 17 or 18 wherein, receiving the 5G time reference comprises receiving the 5G time reference in a dedicated message.

22. The method of claim 13 wherein receiving the 5G time reference comprises:
receiving the requested system information block in a broadcast message without the 5G time reference being included; and
receiving the 5G time reference in a dedicated message.

23. The method of embodiment 21 or 22 wherein, the dedicated message comprises a radio resource control (RRC) message.

24. The method of claim 23 wherein, the RRC message comprises one of a reconfiguration (RRCReconfiguration) message or a downlink (DL) information transfer (DLInformationTransfer) message.

25. A method implemented by a base station of providing time information for time-sensitive communications (TSC), the method comprising:
sending, to a UE, configuration information enabling on-demand requests for a 5G time reference for TSC; and
receiving, from the UE, an on-demand request for system information, the on-demand request including an indication that a 5G time reference is needed by the UE for TSC.

26. The method of embodiment 25 wherein, the configuration information comprises a flag set to a first predetermined value.

21. The method of embodiment 25 wherein, the configuration information comprises a reference to a specific element of system information that contains the 5G time reference.

28. The method of any one of embodiments 25 - 27 wherein, sending the configuration information enabling on-demand requests for a 5G time reference for TSC comprises sending the configuration information in a broadcast message.

29. The method of embodiment 28 wherein, the broadcast message comprises a system information block.

30. The method of any one of embodiments 25 - 27 wherein, sending the configuration information enabling on-demand requests for a 5G time reference for TSC comprises receiving the configuration information in a dedicated message.

31. The method of embodiment 25 wherein, sending the configuration information in a dedicated message comprises receiving the configuration information in a radio resource control (RRC) message.

32. The method of claim 28 wherein, the RRC message comprises one of a reconfiguration (RRCReconfiguration) message or a downlink (DL) information transfer (DLInformationTransfer) message.

### Group C Embodiments

1. A user equipment in a wireless communication network, said user equipment comprising, said user equipment comprising:
interface circuitry configured for communication with one or more serving cells the wireless communication network; and
processing circuitry configured to:
   send, to a base station, an on-demand request for system information, the on-demand request including an indication that a 5G time reference is needed by the UE for TSC; and
   receive, responsive to the on-demand request, the 5G time reference from the base station for TSC.

2. The user equipment according to embodiment 1, wherein the processing circuit is further configured to perform the method of any one of embodiments 2 - 16 in Group A.

3. A user equipment in a wireless communication network, said user equipment being configured to:
send, to a base station, an on-demand request for system information, the on-demand request including an indication that a 5G time reference is needed by the UE for TSC; and
receive, responsive to the on-demand request, the 5G time reference from the base station for TSC.

4. The user equipment of embodiment 17 configured to perform any one of the methods of embodiments 2 - 16 in Group A.

5. A user equipment in a wireless communication network, said user equipment comprising, said user equipment comprising:
interface circuitry configured for communication with one or more serving cells the wireless communication network; and
processing circuitry configured to:
   send, to a base station, an on-demand request for a system information block (SIB) that contains a 5G time reference for TSC; and
   receive, responsive to the on-demand request, the 5G time reference from the base station for TSC.

6. The user equipment according to embodiment 1, wherein the processing circuit is further configured to perform the method of any one of embodiments 18 - 24 in Group A.

7. A user equipment in a wireless communication network, said user equipment being configured to:
send, to a base station, an on-demand request for a system information block (SIB) that contains a 5G time reference for TSC; and
receive, responsive to the on-demand request, the 5G time reference from the base station for TSC.

8. The user equipment of embodiment 17 configured to perform any one of the methods of embodiments 18 - 24 in Group A.

9. A user equipment in a wireless communication network, said user equipment comprising, said user equipment comprising:
interface circuitry configured for communication with one or more serving cells the wireless communication network; and
processing circuitry configured to:
   receive, from the base station, configuration information enabling on-demand requests for a 5G time reference for TSC; and
   send, to the base station, an on-demand request for system information, the on-demand request including an indication that a 5G time reference is needed by the UE for TSC.

10. The user equipment according to embodiment 1, wherein the processing circuit is further configured to perform the method of any one of embodiments 26 - 32 in Group A.

11. A user equipment in a wireless communication network, said user equipment being configured to:
receive, from the base station, configuration information enabling on-demand requests for a 5G time reference for TSC; and
send, to the base station, an on-demand request for system information, the on-demand request including an indication that a 5G time reference is needed by the UE for TSC.

12. The user equipment of embodiment 17 configured to perform any one of the methods of embodiments 26 - 32 in Group A.

13. A computer program comprising executable instructions that, when executed by a processing circuit in a user equipment in a wireless communication network, causes the user equipment to perform any one of the methods of embodiments 1 - 32 in Group A.

14. A carrier containing a computer program of embodiment 13, wherein the carrier is one of an electronic signal, optical signal, radio signal, or computer readable storage medium.

15. A non-transitory computer-readable storage medium containing a computer program comprising executable instructions that, when executed by a processing circuit in a user equipment in a wireless communication network causes the user equipment e to perform any one of the methods of embodiments 1 - 32 in Group A.

16. A wireless device comprising:
processing circuitry configured to perform any of the method of any of the Group A embodiments; and
power supply circuitry configured to supply power to the wireless device.

17. A wireless device comprising:

processing circuitry and memory, the memory containing instructions executable by the processing circuitry whereby the wireless device is configured to perform any of the method of any of the Group A embodiments.

18. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the method of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

19. A computer program comprising instructions which, when executed by at least one processor of a wireless device, causes the wireless device to carry out the method of any of the Group A embodiments.

20. A carrier containing the computer program of embodiment 5, wherein the carrier is one of an electronic signal, optical signal, radio signal, or computer readable storage medium.

### Group D Embodiments

1. A base station in a serving cell of the wireless communication network, said base station comprising:
interface circuitry configured for communication with one or more serving cells the wireless communication network; and
a processing circuit configured to:
   receive, from the UE an on-demand request for system information, the on-demand request including an indication that a 5G time reference is needed by the UE for TSC; and
   send, responsive to the on-demand request, the 5G time reference for TSC to the UE.

2. The base station of embodiment 1 wherein the processing circuit is further configured to perform the method of any one of embodiments 2 - 16 of Group B.

3. A base station in a wireless communication network, said base station being configured to:
receive, from the UE an on-demand request for system information, the on-demand request including an indication that a 5G time reference is needed by the UE for TSC; and
send, responsive to the on-demand request, the 5G time reference for TSC to the UE.

4. The user equipment of embodiment 3 configured to perform any one of the methods of embodiments 2 - 16 of Group B.

5. A base station in a serving cell of the wireless communication network, said base station comprising:
interface circuitry configured for communication with one or more serving cells the wireless communication network; and
a processing circuit configured to:
   receive, from the UE, an on-demand request for a system information block (SIB) that contains a 5G time reference for TSC; and
   send, responsive to the on-demand request, the 5G time reference for TSC to the UE.

6. The base station of embodiment 1 wherein the processing circuit is further configured to perform the method of any one of embodiments 18 - 24 of Group B.

7. A base station in a wireless communication network, said base station being configured to:
receive, from the UE, an on-demand request for a system information block (SIB) that contains a 5G time reference for TSC; and
send, responsive to the on-demand request, the 5G time reference for TSC to the UE.

8. The user equipment of embodiment 3 configured to perform any one of the methods of embodiments 18 - 24 of Group B.

9. A base station in a serving cell of the wireless communication network, said base station comprising:
interface circuitry configured for communication with one or more serving cells the wireless communication network; and
a processing circuit configured to:
   send, to a UE, configuration information enabling on-demand requests for a 5G time reference for TSC; and
   receive, from the UE, an on-demand request for system information, the on-demand request including an indication that a 5G time reference is needed by the UE for TSC.

10. The base station of embodiment 1 wherein the processing circuit is further configured to perform the method of any one of embodiments 25 - 32 of Group B.

11. A base station in a wireless communication network, said base station being configured to:
send, to a UE, configuration information enabling on-demand requests for a 5G time reference for TSC; and
receive, from the UE, an on-demand request for system information, the on-demand request including an indication that a 5G time reference is needed by the UE for TSC

12. The user equipment of embodiment 3 configured to perform any one of the methods of embodiments 25 - 32 of Group B.

13. A computer program comprising executable instructions that, when executed by a processing circuit in a base station in a wireless communication network, causes the base station to perform the method of any one of the Group B embodiments.

14. A carrier containing a computer program of embodiment 13, wherein the carrier is one of an electronic signal, optical signal, radio signal, or computer readable storage medium.

15. A non-transitory computer-readable storage medium containing a computer program comprising executable instructions that, when executed by a processing circuit in a base station in a wireless communication network causes the base station to perform the method of any one of the Group B embodiments

16. A base station configured to perform any of the method of any of the Group B embodiments.

17. A base station comprising:
processing circuitry configured to perform any of the method of any of the Group B embodiments;
power supply circuitry configured to supply power to the wireless device.

18. A base station comprising:

processing circuitry and memory, the memory containing instructions executable by the processing circuitry whereby the base station is configured to perform the method of any one of the Group B embodiments.

19. A computer program comprising instructions which, when executed by at least one processor of a base station, causes the base station to carry out the method of any one of the Group B embodiments.

20. A carrier containing the computer program of embodiment 19, wherein the carrier is one of an electronic signal, optical signal, radio signal, or computer readable storage medium.

### Group E Embodiments

1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station’s processing circuitry configured to perform the method of any of the Group B embodiments.

2. The communication system of the pervious embodiment further including the base station.

3. The communication system of the previous 2 embodiments, further including the UE, wherein the UE is configured to communicate with the base station.

4. The communication system of the previous 3 embodiments, wherein:
the processing circuitry of the host computer is configured to execute a host application, thereby providing the user data; and
the UE comprises processing circuitry configured to execute a client application associated with the host application.

5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the method of any of the Group B embodiments.

6. The method of the previous embodiment, further comprising, at the base station, transmitting the user data.

7. The method of the previous 2 embodiments, wherein the user data is provided at the host computer by executing a host application, the method further comprising, at the UE, executing a client application associated with the host application.

8. A user equipment (UE) configured to communicate with a base station, the UE comprising a radio interface and processing circuitry configured to perform any of the previous 3 embodiments.

9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE’s components configured to perform any of the method of any of the Group A embodiments.

10. The communication system of the previous embodiment, wherein the cellular network further includes a base station configured to communicate with the UE.

11. The communication system of the previous 2 embodiments, wherein:
the processing circuitry of the host computer is configured to execute a host application, thereby providing the user data; and
the UE’s processing circuitry is configured to execute a client application associated with the host application.

12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the method of any of the Group A embodiments.

13. The method of the previous embodiment, further comprising at the UE, receiving the user data from the base station.

14. A communication system including a host computer comprising:
communication interface configured to receive user data originating from a transmission from a user equipment (UE) to a base station,
wherein the UE comprises a radio interface and processing circuitry, the UE’s processing circuitry configured to perform any of the method of any of the Group A embodiments.

15. The communication system of the previous embodiment, further including the UE.

16. The communication system of the previous 2 embodiments, further including the base station, wherein the base station comprises a radio interface configured to communicate with the UE and a communication interface configured to forward to the host computer the user data carried by a transmission from the UE to the base station.

17. The communication system of the previous 3 embodiments, wherein:
the processing circuitry of the host computer is configured to execute a host application; and
the UE’s processing circuitry is configured to execute a client application associated with the host application, thereby providing the user data.

18. The communication system of the previous 4 embodiments, wherein:
the processing circuitry of the host computer is configured to execute a host application, thereby providing request data; and
the UE’s processing circuitry is configured to execute a client application associated with the host application, thereby providing the user data in response to the request data.

19. A method implemented in a communication system including a host computer, a base station and a user equipment (UE), the method comprising:

at the host computer, receiving user data transmitted to the base station from the UE, wherein the UE performs any of the method of any of the Group A embodiments.

20. The method of the previous embodiment, further comprising, at the UE, providing the user data to the base station.

21. The method of the previous 2 embodiments, further comprising:
at the UE, executing a client application, thereby providing the user data to be transmitted; and
at the host computer, executing a host application associated with the client application.

22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

23. A communication system including a host computer comprising a communication interface configured to receive user data originating from a transmission from a user equipment (UE) to a base station, wherein the base station comprises a radio interface and processing circuitry, the base station’s processing circuitry configured to perform any of the method of any of the Group B embodiments.

24. The communication system of the previous embodiment further including the base station.

25. The communication system of the previous 2 embodiments, further including the UE, wherein the UE is configured to communicate with the base station.

26. The communication system of the previous 3 embodiments, wherein:
the processing circuitry of the host computer is configured to execute a host application;
the UE is configured to execute a client application associated with the host application, thereby providing the user data to be received by the host computer.

27. A method implemented in a communication system including a host computer, a base station and a user equipment (UE), the method comprising:

at the host computer, receiving, from the base station, user data originating from a transmission which the base station has received from the UE, wherein the UE performs any of the method of any of the Group A embodiments.

28. The method of the previous embodiment, further comprising at the base station, receiving the user data from the UE.

29. The method of the previous 2 embodiments, further comprising at the base station, initiating a transmission of the received user data to the host computer.

1. A method implemented by a user equipment (UE) of obtaining time information, the method comprising:
sending, to a base station, a message including an indication that a 5G time reference is needed by the UE; and
receiving from the base station, responsive to the indication, system information comprising the 5G time reference.

2. The method of claim 1, wherein, the message comprises an on-demand request for a specific system information block (SIB) containing the 5G time reference and/or on-demand system information comprising the 5G time reference.

3. The method of claim 2 wherein, the system information comprising the 5G time reference is received in SIB9.

4. The method of claim 1 wherein, the indication comprises a flag set to a first predetermined value.

5. The method of claim 1 wherein, the indication comprises a reference to a specific element of system information that contains the 5G time reference.

6. The method of claim 1 wherein, receiving the system information comprising the 5G time reference comprises receiving the 5G time reference in a broadcast message.

7-10. (canceled)

11. The method of claim 1, wherein the 5G time reference is for time sensitive communications (TSC).

12. The method of claim 1 further comprising, before sending the message to the base station:
receiving, from the base station, configuration information enabling on-demand requests for the 5G time reference.

13. The method of claim 12 wherein, the configuration information comprises a flag set to a first predetermined value.

14. The method of claim 12 wherein, the configuration information comprises a reference to a specific element of system information that contains the 5G time reference.

15. The method of claim 12 wherein, receiving the configuration information enabling on-demand requests for a 5G time reference comprises receiving the configuration information in a broadcast message.

16-17. (canceled)

18. The method of claim 12 wherein, receiving the configuration information in a dedicated message comprises receiving the configuration information in a radio resource control (RRC) message.

19. The method of claim 18 wherein, the RRC message comprises one of a reconfiguration (RRCReconfiguration) message or a downlink (DL) information transfer (DLInformationTransfer) message.

20. A method implemented by a base station of time information to a user equipment (UE), the method comprising:
receiving, from the UE, a message including an indication that a 5G time reference is needed by the UE; and
sending to the UE, responsive to the Indication, system information comprising the 5G time reference.

21. The method of claim 20, wherein, the message comprises an on-demand request is for a specific system information block (SIB) containing the 5G time reference and/or on-demand system information comprising the 5G time reference.

22. The method of claim 21 wherein, the system information comprising the 5G time reference is received in SIB9.

23. (canceled)

24. The method of claim 20 wherein, the indication comprises a reference to a specific element of system information that contains the 5G time reference.

25-29. (canceled)

30. The method of claim 20, wherein the 5G time reference is for time sensitive communications (TSC).

31. The method of claim 20 further comprising, before sending the on-demand request to the base station:
sending, to the UE, configuration information enabling on-demand requests for the 5G time reference.

32. (canceled)

33. The method of claim 31 wherein, the configuration information comprises a reference to a specific element of system information that contains the 5G time reference.

34. The method of claim 31 wherein, receiving the configuration information enabling on-demand requests for a 5G time reference comprises receiving the configuration information in a broadcast message.

35-36. (canceled)

37. The method of claim 31 wherein, receiving the configuration information in a dedicated message comprises receiving the configuration information in a radio resource control (RRC) message.

38. (canceled)

39. A user equipment in a wireless communication network, said user equipment being configured to:
send, to a base station, a message including an indication that a 5G time reference is needed by the UE; and
receive from the base station, responsive to the indication, system information comprising the 5G time reference.

40-43. (canceled)

44. A base station in a wireless communication network, said base station being configured to:
receive, from the UE, a message including an indication that a 5G time reference is needed by the UE; and
send to the UE, responsive to the indication, system information comprising the 5G time reference.

45-48. (canceled)
